(19) United States
(12) Patent Application Publication
(10) Pub. No.: US 2012/0276427 A1
(43) Pub. Date: Nov. 1, 2012

(54) RECHARGEABLE BATTERY

(76) Inventor: Duk-Jung KIM, Yongin-si (KR)

(21) Appl. No.: 13/194,746

(22) Filed: Jul. 29, 2011

(30) Foreign Application Priority Data
Apr. 26, 2011 (KR) 10-2011-0039068

(51) Int. Cl. H01M 10/48

(52) U.S. Cl. 429/90

(57) ABSTRACT

A rechargeable battery including an electrode assembly including first and second electrodes, and a separator between the first and second electrodes; a case housing the electrode assembly; a cap plate closing an opening of the case; an electrode terminal in a terminal hole of the cap plate and electrically connected to the electrode assembly, the electrode terminal having a penetration hole for connecting an inside and an outside of the case; and a piezoelectric element in the penetration hole, the piezoelectric element configured to detect a change of pressure inside the case and transmit a detection signal to the outside of the case.

### CROSS-REFERENCE TO RELATED APPLICATION

This application claims priority to and the benefit of Korean Patent Application No. 10-2011-0039068, filed on Apr. 26, 2011 in the Korean Intellectual Property Office, the entire content of which is incorporated herein by reference.

### BACKGROUND

1. Field

Aspects of embodiments of the present invention relate to a rechargeable battery.

2. Description of the Related Art

Unlike a primary battery, a rechargeable battery can repeatedly perform charging and discharging. A small-capacity rechargeable battery is typically used in a portable small-sized electronic device such as a mobile phone, a notebook computer, and a camcorder, and a large-capacity rechargeable battery may be used as a power supply for driving a motor, such as a motor for an electric vehicle or a hybrid electric vehicle.

For example, a rechargeable battery having small capacity may be used for a unit cell, and a plurality of rechargeable batteries, or unit cells, may be combined in series or in parallel to form a module having large capacity. In order to securely and accurately control the rechargeable battery and increase its cycle-life, a battery management system may be connected to the unit cells.

For example, the battery management system may control the unit cells according to voltages of the unit cells, charging and discharging capacity, current, temperature, and/or internal pressure. Particularly, when the internal pressure is increased, the unit cells may explode. Therefore, a pressure sensor may be installed in the unit cell to detect an internal pressure of the unit cell and apply the same to the battery management system.

However, when the pressure sensor is installed outside the rechargeable battery, accuracy of the detected pressure value is low. On the other hand, when the pressure sensor is installed inside the rechargeable battery, additional installation space is required. Also, the pressure sensor may detect rising of the internal pressure, but may fail to detect a decreasing of the internal pressure.

The above information disclosed in this Background section is only for enhancement of understanding of the background of the invention, and therefore it may contain information that does not form the prior art that is already known in this country to a person of ordinary skill in the art.

### SUMMARY

According to an aspect of embodiments of the present invention, a rechargeable battery checks an internal mechanical state by measuring a change of internal pressure. Rechargeable batteries according to embodiments of the present invention may thereby have improved safety as a motor-driving power source for propelling electric scooters, hybrid vehicles, or electric vehicles.

According to another aspect of embodiments of the present invention, a rechargeable battery has an improved degree of control freedom and accuracy of a battery management system.

According to an exemplary embodiment of the present invention, a rechargeable battery includes: an electrode assembly including first and second electrodes, and a separator between the first and second electrodes; a case housing the electrode assembly; a cap plate closing an opening of the case; an electrode terminal in a terminal hole of the cap plate and electrically connected to the electrode assembly, the electrode terminal having a penetration hole for connecting an inside and an outside of the case; and a piezoelectric element in the penetration hole, the piezoelectric element configured to detect a change of pressure inside the case and transmit a detection signal to the outside of the case.

In one embodiment, the electrode terminal includes a flange on an inner side of the cap plate, and the rechargeable battery further includes an insulating member between the flange and the cap plate. The penetration hole may extend through a center of the electrode terminal in a lengthwise direction of the electrode terminal.

The penetration hole may include a receiving space extending in the flange and receiving the piezoelectric element.

The rechargeable battery may further include a gasket in the receiving space and arranged between the piezoelectric element and the flange.

The rechargeable battery may further include a cable connected to the piezoelectric element and extending in the penetration hole to an outside of the electrode terminal.

In one embodiment, the rechargeable battery further includes a lead tab connecting the electrode terminal and the electrode assembly, and the lead tab is electrically connected to the flange of the electrode terminal and supports the piezoelectric element. The lead tab may be received in a receiving space of the insulating member.

The lead tab may include a support groove supporting the piezoelectric element and the gasket.

The electrode terminal may further include a coupling protrusion protruding toward the support groove from an inner side of the flange, and the coupling protrusion may be received in the support groove.

In one embodiment, the lead tab has an opening at a center of the support groove, and the piezoelectric element includes a protruded portion protruding toward and received in the opening.

The rechargeable battery may further include: an internal cable in the penetration hole and connected to the piezoelectric element; and a connector connected between the internal cable and the outside of the case.

In one embodiment, the electrode terminal includes a protruding portion protruding to an outer side of the cap plate, and the rechargeable battery further includes a gasket between the protruding portion and the cap plate; and a nut on the outer side of the cap plate and fastening the protruding portion to the cap plate.

According to an aspect of embodiments of the present invention, in a rechargeable battery, a penetration hole is formed in an electrode terminal and a piezoelectric element is installed in the penetration hole to provide high accuracy of a detected value and detect a change of internal pressure of the rechargeable battery, thereby checking an internal mechanical state thereof. According to another aspect of embodiments of the present invention, the piezoelectric element is installed in the penetration hole of the electrode terminal such that no additional installation space is needed. According to another aspect of embodiments of the present invention, the piezoelectric element detects a decrease of the pressure caused by a rise of the internal pressure and leakage of the electrolyte solution, thereby providing a high degree of control freedom and accuracy of the battery management system.

### BRIEF DESCRIPTION OF THE DRAWINGS

FIG. 1 is a perspective view of a rechargeable battery according to an exemplary embodiment of the present invention.

FIG. 2 is a cross-sectional view of the rechargeable battery of FIG. 1, taken at the line II-II.

FIG. 3 is a cross-sectional view of the rechargeable battery of FIG. 1, taken at the line III-III of FIG. 2.

FIG. 4 is an enlarged cross-sectional view of a region IV of FIG. 2.

FIG. 5 is an exploded perspective view of a portion of the rechargeable battery shown in FIG. 4.

FIG. 6 is a partial cross-sectional view of a rechargeable battery according to another exemplary embodiment of the present invention.

### DETAILED DESCRIPTION

Aspects of the present invention will be described more fully hereinafter with reference to the accompanying drawings, in which some exemplary embodiments of the present invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

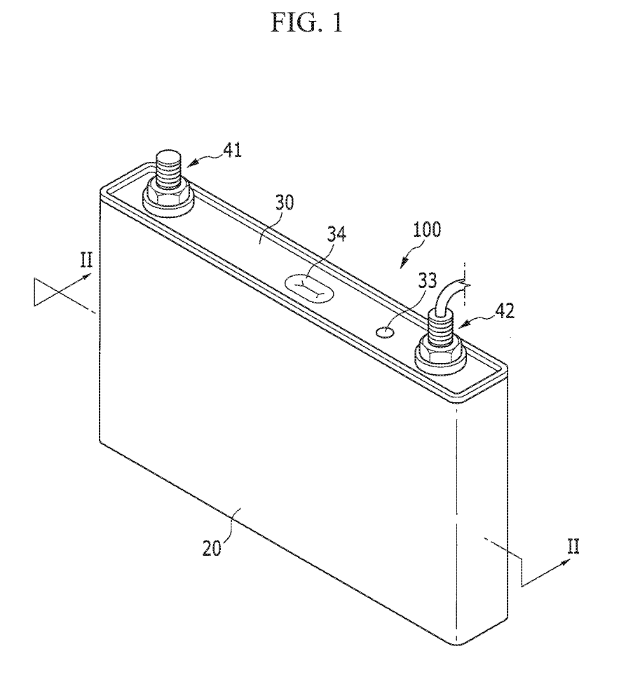

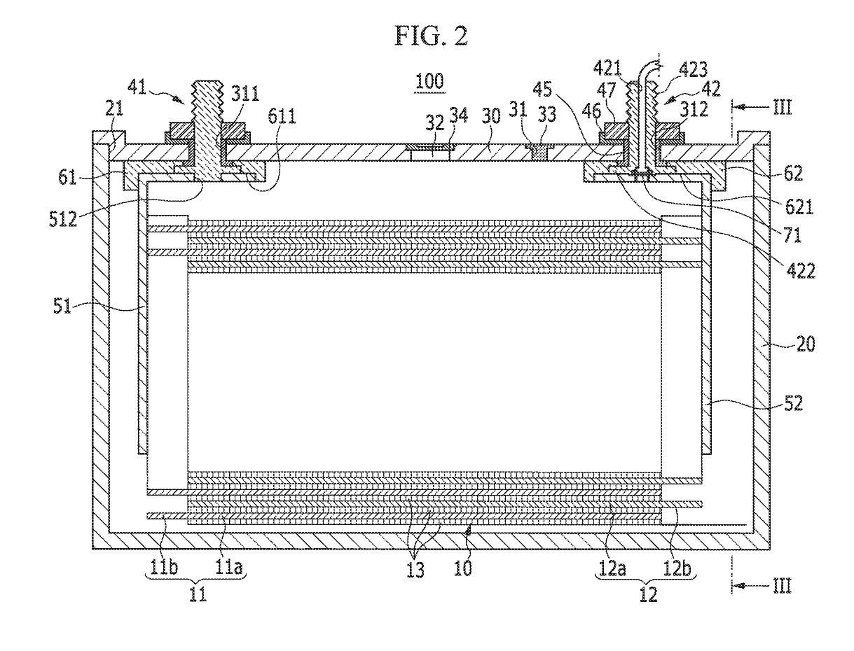

FIG. 1 is a perspective view of a rechargeable battery 100 according to an exemplary embodiment of the present invention, and FIG. 2 is a cross-sectional view of the rechargeable battery 100, taken at the line II-II of FIG. 1. Referring to FIGS. 1 and 2, the rechargeable battery 100 includes an electrode assembly 10 to be charged and discharged, a case 20 housing the electrode assembly 10 and an electrolyte solution, a cap plate 30 combined with (e.g., closing, or sealing) an opening of the case 20, first and second (e.g., negative and positive) electrode terminals 41 and 42 installed in the cap plate 30, and first and second (e.g., negative and positive) electrode lead tabs 51 and 52 for electrically connecting the first and second electrode terminals 41 and 42 to the electrode assembly 10.

The electrode assembly 10 includes a first (e.g., negative) electrode 11, a second (e.g., positive) electrode 12, and a separator 13 (e.g., an insulator) between the first and second electrodes 11 and 12. In one embodiment, the electrode assembly 10 is formed by winding the stacked first electrode 11, the separator 13, and the second electrode 12 as a jelly roll. For example, in one embodiment, the electrode assembly 10 may be assembled by stacking the first electrode 11 and the second electrode 12 that are respectively formed as a single substrate with the separator 13 therebetween, or in another embodiment, the electrode assembly 10 may be assembled by folding and stacking the first electrode 11, the separator 13, and the second electrode 12 in a zigzag manner (not shown).

The first and second electrodes 11 and 12, in one embodiment, include coated regions 11a and 12a formed by coating an active material on a current collecting material, and uncoated regions 11b and 12b formed by an exposed part of the current collecting material that is not coated with the active material on each side of the coated regions 11a and 12a. For example, in one embodiment, the current collecting material of the first electrode 11 is formed of copper, and the current collecting material of the second electrode 12 is formed of aluminum.

The uncoated region 11b of the first electrode 11 is formed at an end of the first electrode 11 along the wound first electrode 11. The uncoated region 12b of the second electrode 12 is formed at an end of the second electrode 12 along the second electrode 12. That is, in one embodiment, the uncoated regions 11b and 12b of the first and second electrodes 11 and 12 are disposed on both ends of the electrode assembly 10, and are mechanically and electrically connected to the first and second electrode lead tabs 51 and 52.

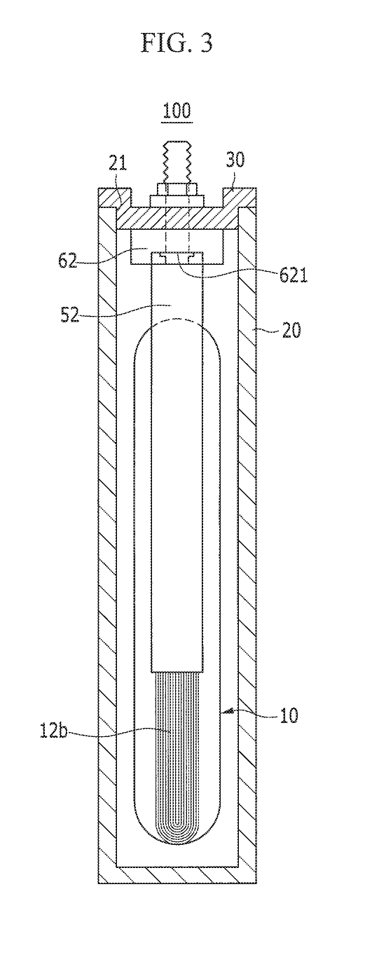

FIG. 3 is a cross-sectional view of the rechargeable battery 100, taken at the line of FIG. 2. Referring to FIGS. 2 and 3, the case 20 has an opening 21 at one end, and the opening 21 forms a receiving space for the electrode assembly 10 and the electrolyte solution. The electrode assembly 10 is inserted into the case 20 through the opening 21. In one embodiment, the case 20 may be cuboidal.

The cap plate 30 is combined with (e.g., closes, or seals) the opening 21 of the case 20 after the electrode assembly 10 is received in the case 20, thereby setting and closing the receiving space of the case 20. In one embodiment, the cap plate 30 is welded to the case 20, and the case 20 and the cap plate 30 are made of aluminum such that they have an excellent welding property when combined and welded.

The cap plate 30, in one embodiment, includes an electrolyte solution inlet 31 and a vent hole 32. The electrolyte solution inlet 31 provides an electrolyte solution inlet path into the case 20 when the cap plate 30 is combined with the case 20. After the electrolyte solution is injected, the electrolyte solution inlet 31 is sealed with a sealing cap 33.

The vent hole 32 provides a discharge path for discharging gas generated by decomposition of the electrolyte solution to the outside of the rechargeable battery 100 when the electrode assembly 10 is charged or discharged. The vent hole 32, in one embodiment, is closed and sealed by a vent plate 34 that can be broken in order to prevent or substantially prevent explosion of the rechargeable battery 100. That is, when an internal pressure of the rechargeable battery 100 reaches a certain pressure (e.g., a predetermined pressure), the vent plate 34 is broken to open the vent hole 32 and thereby discharge the gas from the rechargeable battery 100.

The first and second electrode terminals 41 and 42 are installed in terminal holes 311 and 312 of the cap plate 30, respectively, and are electrically connected to the electrode assembly 10 through the first and second electrode lead tabs 51 and 52. In one embodiment, the first and second electrode lead tabs 51 and 52 are connected to the first and second electrodes 11 and 12 of the electrode assembly 10, respectively, at one side (e.g., an end of the respective lead tab), and are connected to the first and second electrode terminals 41 and 42, respectively, at another side (e.g., an opposite end of the respective lead tab). The first and second electrode lead tabs 51 and 52, in one embodiment, may be connected to the first and second electrodes 11 and 12 of the electrode assembly 10, respectively, by ultrasonic welding and/or laser welding.

Insulating members 61 and 62 are provided between the first and second electrode lead tabs 51 and 52 and the inside (e.g., an inner surface) of the cap plate 30 to electrically insulate the first and second electrode lead tabs 51 and 52 from the cap plate 30. The insulating members 61 and 62 include receiving spaces 611 and 621, respectively, that are open toward the electrode assembly 10 so as to receive and support connected parts of the first and second electrode terminals 41 and 42 and the first and second electrode lead tabs 51 and 52.

The rechargeable battery 100 according to an exemplary embodiment of the present invention includes a piezoelectric element 71 for detecting a change of internal pressure of the rechargeable battery 100, that is, rising and falling of the internal pressure. For example, the electrode assembly 10 may be swelled by an increase of pressure, and the rechargeable battery 100 is configured to check a mechanical state inside the case 20 according to a detection signal (e.g., a positive voltage) of the piezoelectric element 71. Further, the internal pressure decreases by leakage of an electrolyte solution, and the rechargeable battery 100 is configured to check for leakage of the electrolyte solution according to the detection signal (e.g., a negative voltage) of the piezoelectric element 71. The rechargeable battery 100 thereby has improved safety, and may be particularly applicable as a motor-driving power source for propelling electric scooters, hybrid vehicles, or electric vehicles.

The piezoelectric element 71 is configured to apply the change of the voltage occurring by a change of the internal pressure of the rechargeable battery 100 to the battery management system (not shown) connected to the outside of the rechargeable battery 100. Accordingly, the piezoelectric element 71 is arranged to be exposed to the interior space at which the internal pressure of the rechargeable battery 100 is directly applicable, and the piezoelectric element 71 directly detects the internal pressure.

In the rechargeable battery 100 according to one embodiment, the second electrode terminal 42 has a penetration hole 421 formed therein for connecting the inside and the outside of the case 20, and the piezoelectric element 71 is arranged in the penetration hole 421. The penetration hole 421 provides a space for installing or receiving the piezoelectric element 71 such that the internal space of the rechargeable battery 100 is not used by the piezoelectric element 71. In one embodiment, the internal pressure of the rechargeable battery 100 may be applied to the piezoelectric element 71 through the penetration hole 421.

In one embodiment, the piezoelectric element 71 is installed in the second (e.g., positive) electrode terminal 42, and although not shown, in another embodiment, the piezoelectric element 71 may be installed in the first (e.g., negative) electrode terminal 41, or in both the first and second electrode terminals 41 and 42. In an embodiment in which piezoelectric elements 71 are installed in both the first and second electrode terminals 41 and 42, an internal pressure of the rechargeable battery 100 can still be detected when one of the piezoelectric elements 71 is not working.

In one embodiment, as depicted in FIG. 2, the rechargeable battery 100 includes the piezoelectric element 71 that is installed in the second electrode terminal 42, and no piezoelectric element is installed in the first electrode terminal 41. In one embodiment, the first electrode terminal 41 may be electrically and mechanically connected to the first electrode lead tab 51 by inserting an internal end of the first electrode terminal 41 into a penetration hole 512 of the first electrode lead tab 51 and caulking the inserted end.

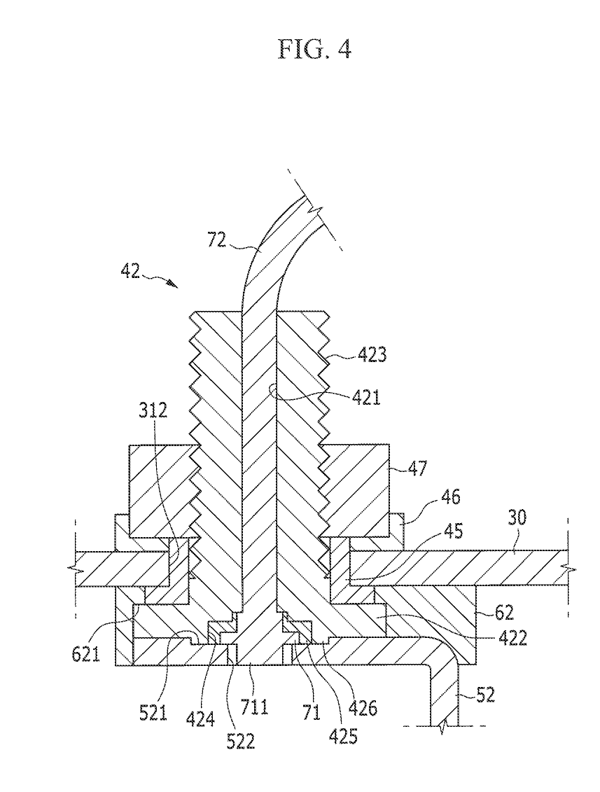

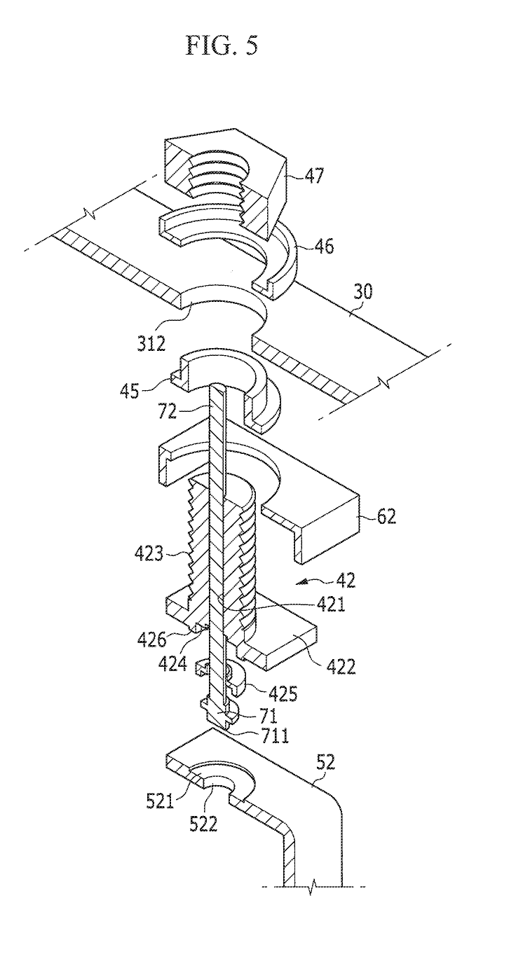

FIG. 4 is an enlarged cross-sectional view of a portion of the rechargeable battery 100 showing a state in which the cap plate 30 and the second electrode terminal 42 are combined, and FIG. 5 is an exploded perspective view showing some components of the rechargeable battery 100 shown in FIG. 4. Referring to FIGS. 2, 4, and 5, in one embodiment, the second electrode terminal 42 includes a flange 422 on an inner side (e.g., an inner surface) of the cap plate 30, and a protruding portion 423 (e.g., a threaded portion) protruding to the outside of the cap plate 30.

In one embodiment, the insulating member 62 is supported between the flange 422 and the cap plate 30 (e.g., an inner surface of the cap plate 30). In one embodiment, the protruding portion 423 is arranged in, and extends through, the terminal hole 312, and a gasket 45 is also arranged in the terminal hole 312 between the protruding portion 423 and the edge of the terminal hole 312 and seals the second electrode terminal 42 and the terminal hole 312 of the cap plate 30. In one embodiment, the flange 422 is received in the receiving space 621 of the insulating member 62, and the gasket 45 and the insulating member 62 contact and are supported by the cap plate 30. In one embodiment, the protruding portion 423 is fastened by a nut 47, and an insulator 46 is arranged between the nut 47 and the outer side of the cap plate 30, and thereby forms an electrically insulated configuration from the cap plate 30.

By combination of the nut 47 and the protruding portion 423, the second electrode lead tab 52 connected to the flange 422, the insulating member 62, and the gasket 45 is drawn to the inside of the cap plate 30 and is closely attached thereto to firmly form an electrically insulating and sealing configuration. In one embodiment, a plurality of rechargeable batteries 100 may form a module, and the protruding portions 423 of the neighboring rechargeable batteries 100 may be connected to each other by a bus bar (not shown) to connect the rechargeable batteries 100 in series or in parallel.

In one embodiment, the penetration hole 421 of the second electrode terminal 42 is penetrated through the center in the lengthwise direction such that the penetration hole 421 is not closed by the nut 47 or a bus bar (not shown) when the bus bar is installed in the nut 47 fastened with the protruding portion 423 or in the protruding portion 423. The penetration hole 421, in one embodiment, forms a receiving space 424 further extended in the diameter direction of the penetration hole 421 and located at an end of the penetration hole proximate the flange 422. The piezoelectric element 71, in one embodiment, is received in the receiving space 424 and is securely supported therein to detect a change of pressure inside the case 20. In one embodiment, a gasket 425 is arranged between the piezoelectric element 71 and the receiving space 424 to seal a space between the piezoelectric element 71 and the receiving space 424 such that the internal pressure of the case 20 is sealed and may be accurately applied to and detected by the piezoelectric element 71.

The piezoelectric element 71, in one embodiment, is installed in the receiving space 424 and is connected to a cable 72 to transmit the detected pressure signal to the outside of the case 20. The cable 72, in one embodiment, is inserted into the penetration hole 421 and insulated, and is drawn outside the second electrode terminal 42 through the penetration hole 421 from the receiving space 424. In one embodiment, the penetration hole 421 is not closed by the nut 47 and the bus bar such that the cable 72 can be connected and drawn out.

The second electrode lead tab 52, in one embodiment, is received in the receiving space 621 of the insulating member 62 and stacked and electrically connected with the flange 422 of the second electrode terminal 42, and, in one embodiment, supports the piezoelectric element 71 and the gasket 425. In one embodiment, the bottom of the piezoelectric element 71 is supported by the second electrode lead tab 52 such that the gasket 425 arranged adjacent the piezoelectric element 71 in the receiving space 424 may provide firm sealing.

In one embodiment, the second electrode lead tab 52 has a support groove 521 facing the flange 422 to support the piezoelectric element 71 and the gasket 425. Further, in one embodiment, the second electrode terminal 42 may include a coupling protrusion 426 that is protruded toward the support groove 521 from the inside of the center of the flange 422. In one embodiment, the coupling protrusion 426 is received in the support groove 521, and the flange 422 and the second electrode lead tab 52 may be connected (e.g., by welding) from the outside of the coupling protrusion 426.

The second electrode lead tab 52 has a penetration hole 522 formed in the support groove 521 (e.g., in the center of the support groove 521) such that the internal pressure of the case 20 is applied to the piezoelectric element 71. In one embodiment, the piezoelectric element 71 includes a protruded region 711 that is protruded toward and inserted into the penetration hole 522. The protruded region 711, in one embodiment, is maintained at the same level as an inner surface of the second electrode lead tab 52 and can receive the internal pressure of the case 20.

Another exemplary embodiment of the present invention is described below and compared with the embodiment described above. Therefore, further description of components and features which are the same as those described above will not be repeated, and only those having a different configuration is described below.

In the rechargeable battery 100 described above, according to one embodiment, the piezoelectric element 71 and the cable 72 are integrally formed, the piezoelectric element 71 is installed in the receiving space 424 of the penetration hole 421, and the cable 72 is drawn out through the penetration hole 421.

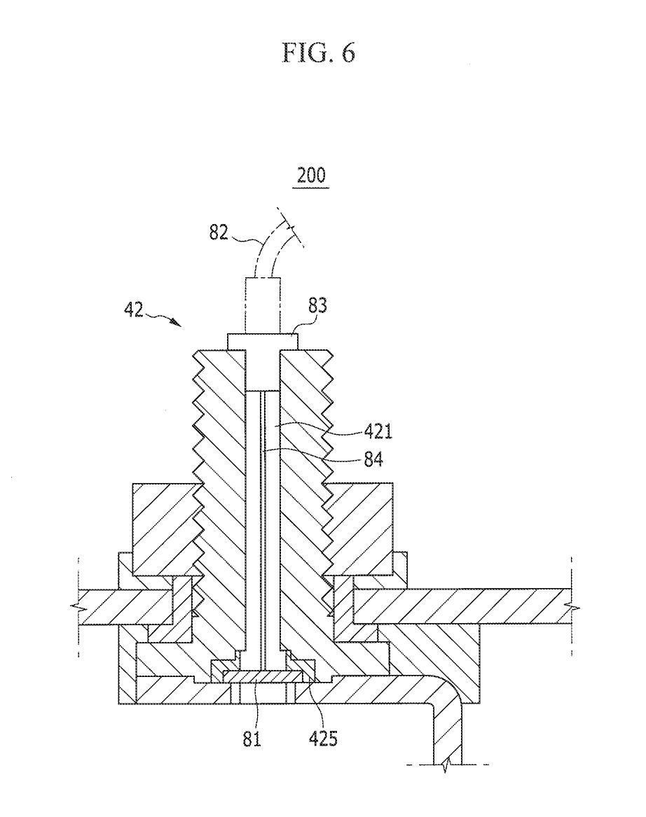

FIG. 6 shows a partial cross-sectional view of a rechargeable battery 200 according to another exemplary embodiment of the present invention. In the rechargeable battery 200 according to one embodiment, a piezoelectric element 81 is separated from an external cable 82 and is connected to the external cable 82 through a connector 83. This separated configuration facilitates selective replacement or repair of the unit cell, the piezoelectric element 81, and the external cable 82 when the unit cell does not work in the module of the rechargeable battery 200 or the piezoelectric element 81 and/or the external cable 82 do not work.

The connector 83 is combined with the penetration hole 421 from the outside of the second electrode terminal 42 and is connected to the piezoelectric element 81 through an internal cable 84. The internal cable 84 is electrically insulated from the second electrode terminal 42 and is arranged inside the penetration hole 421. The connector 83 is electrically connected to a battery management system (not shown) through the external cable 82. In one embodiment, the connector 83 is combined with the penetration hole 421 by sealing, and the sealing effect of the gasket 425 is supplemented.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
an electrode assembly comprising first and second electrodes, and a separator between the first and second electrodes;
a case housing the electrode assembly;
a cap plate closing an opening of the case;
an electrode terminal in a terminal hole of the cap plate and electrically connected to the electrode assembly, the electrode terminal having a penetration hole for connecting an inside and an outside of the case; and
a piezoelectric element in the penetration hole, the piezoelectric element configured to detect a change of pressure inside the case and transmit a detection signal to the outside of the case.

2. The rechargeable battery of claim 1,
wherein the electrode terminal comprises a flange on an inner side of the cap plate, and
wherein the rechargeable battery further comprises an insulating member between the flange and the cap plate.

3. The rechargeable battery of claim 2, wherein the penetration hole extends through a center of the electrode terminal in a lengthwise direction of the electrode terminal.

4. The rechargeable battery of claim 3, wherein the penetration hole includes a receiving space extending in the flange and receiving the piezoelectric element.

5. The rechargeable battery of claim 4, further comprising a gasket in the receiving space and arranged between the piezoelectric element and the flange.

6. The rechargeable battery of claim 5, further comprising a lead tab connecting the electrode terminal and the electrode assembly,
wherein the lead tab is electrically connected to the flange of the electrode terminal and supports the piezoelectric element and the gasket.

7. The rechargeable battery of claim 6, wherein the lead tab is received in a receiving space of the insulating member.

8. The rechargeable battery of claim 6, wherein the lead tab includes a support groove supporting the piezoelectric element and the gasket.

9. The rechargeable battery of claim 8,
wherein the electrode terminal further comprises a coupling protrusion protruding toward the support groove from an inner side of the flange, and
wherein the coupling protrusion is received in the support groove.

10. The rechargeable battery of claim 8,
wherein the lead tab has an opening at a center of the support groove, and
wherein the piezoelectric element comprises a protruded portion protruding toward and received in the opening.

11. The rechargeable battery of claim 3, further comprising a cable connected to the piezoelectric element and extending in the penetration hole to an outside of the electrode terminal.

12. The rechargeable battery of claim 3, further comprising:
an internal cable in the penetration hole and connected to the piezoelectric element; and
a connector connected between the internal cable and the outside of the case.

13. The rechargeable battery of claim 1,
wherein the electrode terminal comprises a protruding portion protruding to an outer side of the cap plate, and
wherein the rechargeable battery further comprises:
a gasket between the protruding portion and the cap plate; and
a nut on the outer side of the cap plate and fastening the protruding portion to the cap plate.
